(19) United States
(12) Patent Application Publication
(10) Pub. No.: US 2006/0171616 A1
(43) Pub. Date: Aug. 3, 2006

(54) Hydrodynamic thrust bearing assembly

(75) Inventors: Aaron P. Richie, Houston, TX (US); Manmohan S. Kalsi, Houston, TX (US)

Correspondence Address: ANDREWS & KURTH, L.L.P., 600 TRAVIS, SUITE 4200, HOUSTON, TX, 77002, US

(73) Assignee: Kalsi Engineering, Inc.

(21) Appl. No.: 11/340,889

(22) Filed: Jan. 27, 2006

Related U.S. Application Data
(60) Provisional application No. 60/649,498, filed on Feb. 3, 2005.

(51) Int. Cl. F16C 32/06

(52) U.S. Cl. 384/121

(57) ABSTRACT

A thrust bearing assembly including a ring-like support structure having a castellated end configuration, a ring-like dynamic race, and a ring-like thrust washer sandwiched between the castellated end configuration and the dynamic race. The castellated end configuration defines a plurality of support regions and a plurality of notches between adjacent support regions. The thrust washer sits atop the castellations of the support structure. The castellated end configuration of the support structure provides intermittent support regions and intermittent unsupported regions to the thrust washer. When a thrust load is applied to the bearing assembly, the thrust washer elastically flexes at the unsupported regions and creates undulations in the washer's dynamic surface to create an initial hydrodynamic fluid wedge with respect to a mating surface of the dynamic race. The gradually converging geometry created by these undulations promotes a strong hydrodynamic action that wedges a lubricant film of a predictable magnitude into the dynamic interface between the thrust washer and the dynamic race in response to relative rotation. This lubricant film physically separates the dynamic surfaces of the thrust washer and dynamic race from each other, thus minimizing asperity contact, and reducing friction, wear and bearing-generated heat, while permitting operation at higher load and speed combinations.

### CROSS-REFERENCE TO RELATED APPLICATIONS

This application claims the benefit of U.S. Provisional Application Ser. No. 60/649,498, filed Feb. 4, 2005, and entitled “Sealed Bearing Assembly”.

### BACKGROUND OF THE INVENTION

1. Field of the Invention

The present invention relates generally to thrust bearing assemblies, and more particularly to thrust bearing assemblies providing hydrodynamic lubrication of the loaded bearing surfaces in response to relative rotation.

2. Description of the Related Art

Rotary drilling techniques are used to penetrate into the earth to create wells for obtaining oil and gas. In order to drill through the rock that is encountered in such endeavors, a drill bit is employed at the bottom of a hollow drill string.

In many cases, rotary motion is imparted to the drill bit by a downhole mud motor that employs a sealed bearing assembly containing thrust and radial bearings that guide the rotation of the drill bit, and transfer the weight of the drill string to the drill bit. Mud motor sealed bearing assemblies are well known in the prior art; for example, see U.S. Pat. Nos. 3,730,284; 5,195,754; 5,248,204; 5,664,891; and 6,416,225.

The thrust bearings that are employed in mud motor sealed bearing assemblies are typically conventional roller thrust bearings. Relative to their small size, these bearings are severely loaded, and the bearing contact stresses reach extremely high levels, especially during severe impact loading. The races of roller thrust bearings are subject to Brinnelling-type damage from the high impact forces that are encountered in drilling operations, which can lead to premature bearing failure.

In order to replace the mud motor at the end of its useful life, it is necessary to first pull the entire drill string from the well. The downtime associated with the lengthy round trips required for such replacement can be a significant component of the cost of drilling a well, particularly in wells of great depth. A significant reduction in the cost of oil and gas well drilling can therefore be obtained by improving the reliability and life of the thrust bearing used in oilfield mud motors.

Assignee's U.S. Pat. No. 6,460,635 discloses a load responsive hydrodynamic thrust bearing in which the thrust bearing has a dynamic surface and a static surface. The thrust bearing is sandwiched between first and second surfaces which are relatively rotatable with respect to one another. Preferably, the dynamic surface is a substantially flat surface with no interruptions whereas the static surface has interruptions caused by multiple undercut regions defining multiple flexing regions. The commercial thrust bearings sold under Assignee's '635 are manufactured by cutting radial grooves into the bearing element itself, thus complicating the machining of the bearing, which is discarded once it wears out.

Additionally, the commercial thrust bearings sold commercially under Assignee's '635 Patent have grooves on the static side of the bearing that leave portions of the bearing quite thin. When such thrust bearings wear significantly, they begin to behave non-hydrodynamically as if they were plain thrust washers. This is especially true if the rotary seals wear out first allowing abrasive drilling fluid to enter the bearing. The resulting wear thins the bearing more and more over time. Ultimately, the bearing breaks into segments when the thinnest portions of the bearing are worn through.

It is desirable to have a reliable, compact, impact-resistant thrust bearing assembly for use in mechanical equipment subject to high bearing loads, including oilfield mud motor sealed bearing assemblies and other rotary equipment. It is further desirable to have a thrust bearing assembly that is load responsive and provides hydrodynamic lubrication of the bearing dynamic surfaces in response to relative rotation. It is further desirable to have a thrust bearing assembly that carries heavy loads at high speeds while generating less heat than prior art non-hydrodynamic thrust bearings. It is further desirable that the thrust bearing be economical.

### SUMMARY OF THE INVENTION

It is an objective of the present invention to provide a reliable, economical, impact resistant thrust bearing for use in mechanical equipment subject to high bearing loads, such as oilfield downhole mud motor sealed bearing assemblies used in hard rock drilling and other rotary equipment.

It is another objective of this invention to provide a compact hydrodynamically lubricated bearing that lowers bearing friction to permit operation under higher loads and higher speeds while minimizing bearing wear, preventing seizure, and remaining effective even as wear occurs at the bearing interface.

It is another objective of this invention to reduce bearing generated heat to prevent heat-related degradation of lubricant, bearings, elastomer seals, and associated components.

It is another objective of this invention to provide a compact bearing that can withstand high shock loads without damage, while maintaining low friction operation.

It is another objective of this invention to provide a compact bearing that permits low friction operation over a wide range of loads, and while rotating in either clockwise or counter-clockwise direction.

It is another objective of this invention to provide a reliable thrust bearing assembly for rotary equipment by providing a load responsive, elastically flexing bearing design that provides hydrodynamic lubrication of the loaded dynamic surfaces.

The thrust bearing assembly according to a preferred embodiment of the present invention provides an improved thrust bearing arrangement for supporting and guiding a relatively rotatable member. The arrangement preferably comprises a generally circular ring-like support structure having a castellated end configuration, a thrust washer of generally ring-like design, and a generally circular, ring-like dynamic race.

The preferred castellated end configuration of the support structure defines a plurality of support regions and a plurality of undercut (i.e. notched) regions between adjacent support regions, it being preferred that the undercut regions be open-ended; i.e. passing completely through the support structure from inside to outside. The thrust washer sits atop the castellations of the support structure.

The preferred castellated end configuration of the support structure provides intermittent support to the thrust washer, and also provides intermittent unsupported regions. When a thrust load is applied to the bearing assembly, the thrust washer elastically flexes at the unsupported regions. This flexure creates undulations in the washer's dynamic surface in response to the applied load, to create an initial hydrodynamic fluid wedge with respect to the mating surface of the dynamic race. The gradually converging geometry created by these undulations promotes a strong hydrodynamic action that wedges a lubricant film of a predictable magnitude into the dynamic interface between the thrust washer and the dynamic race in response to relative rotation. This lubricant film physically separates the dynamic surfaces of the thrust washer and dynamic race from each other, thus minimizing asperity contact, and reducing friction, wear and bearing-generated heat, while permitting operation at higher load and speed combinations.

### BRIEF DESCRIPTION OF THE SEVERAL VIEWS OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In the Drawings:

FIG. 1 is a plan view of a hydrodynamic thrust bearing assembly according to a preferred embodiment of the present invention;

FIG. 11A is a section view taken along lines 1A-1A of FIG. 1;

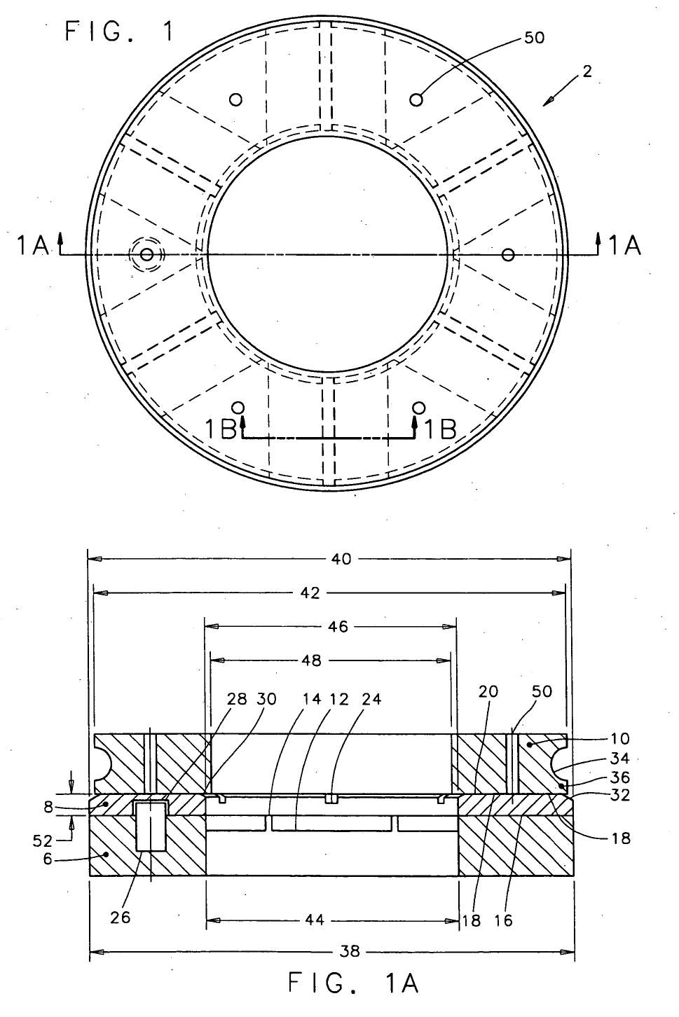

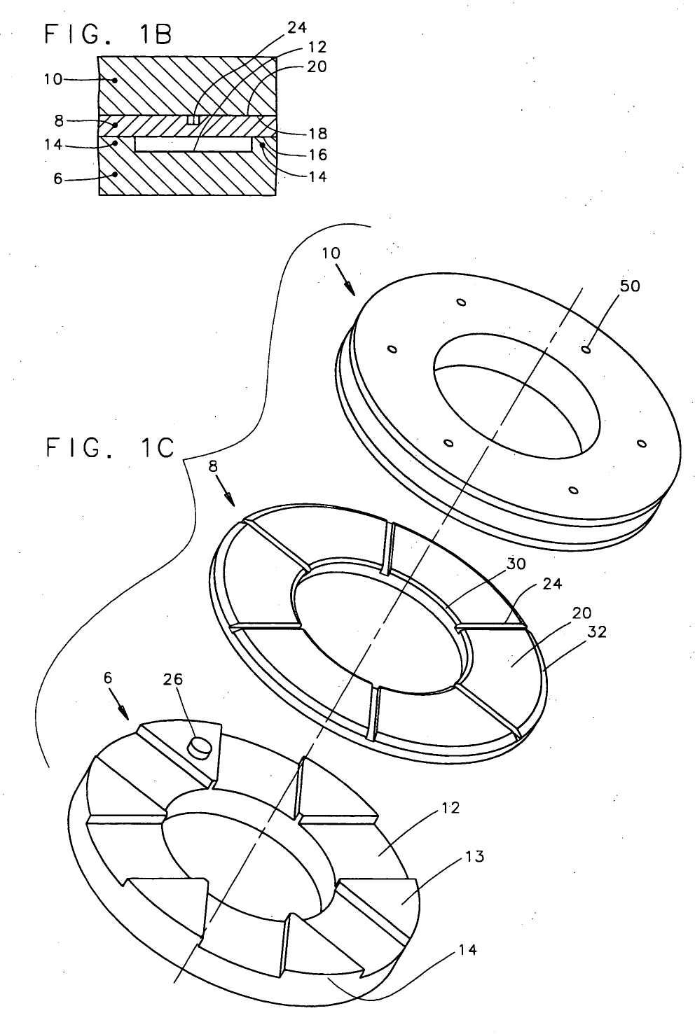

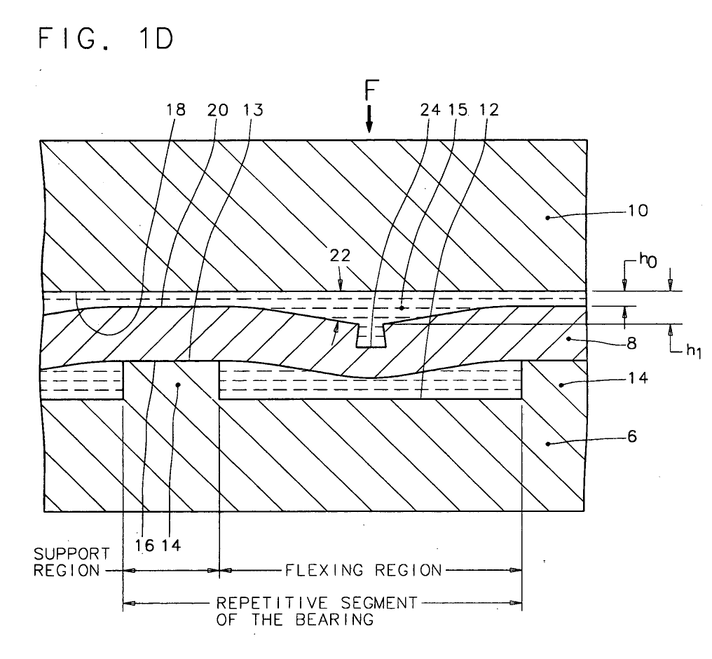

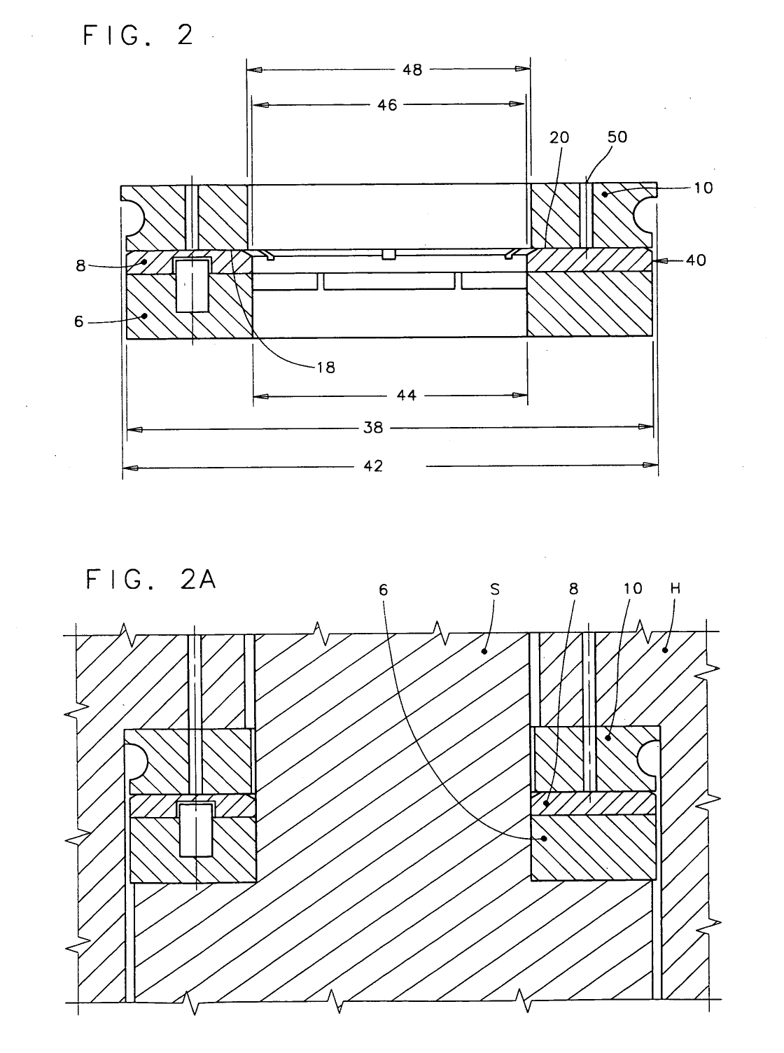

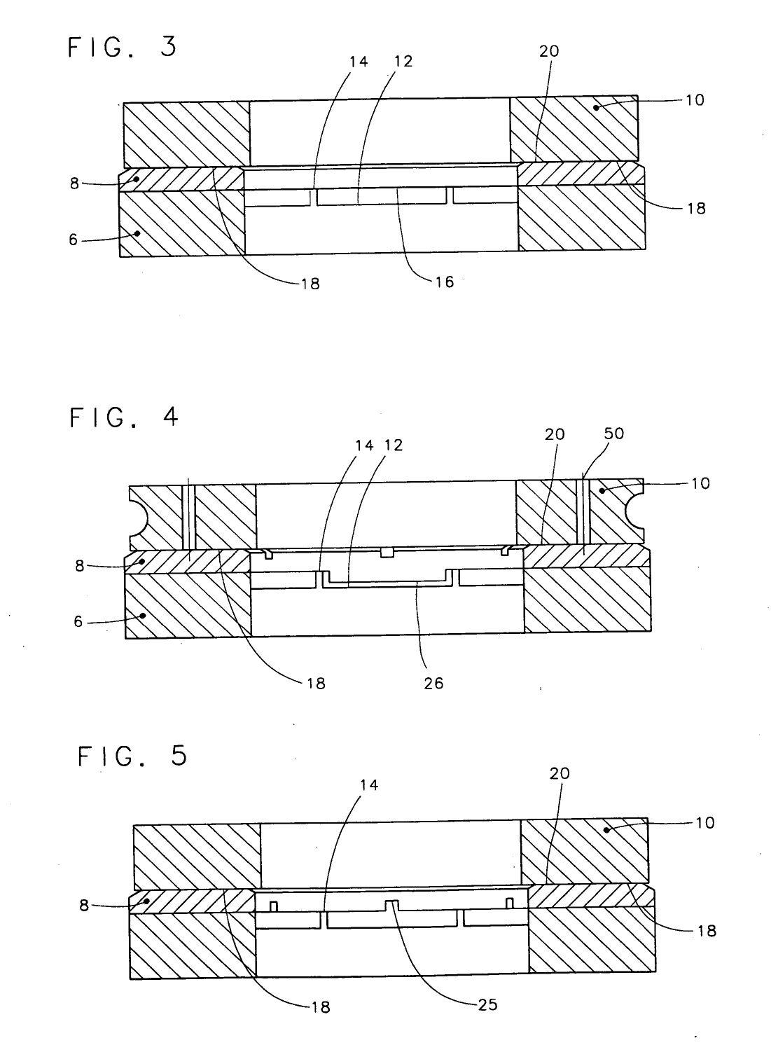

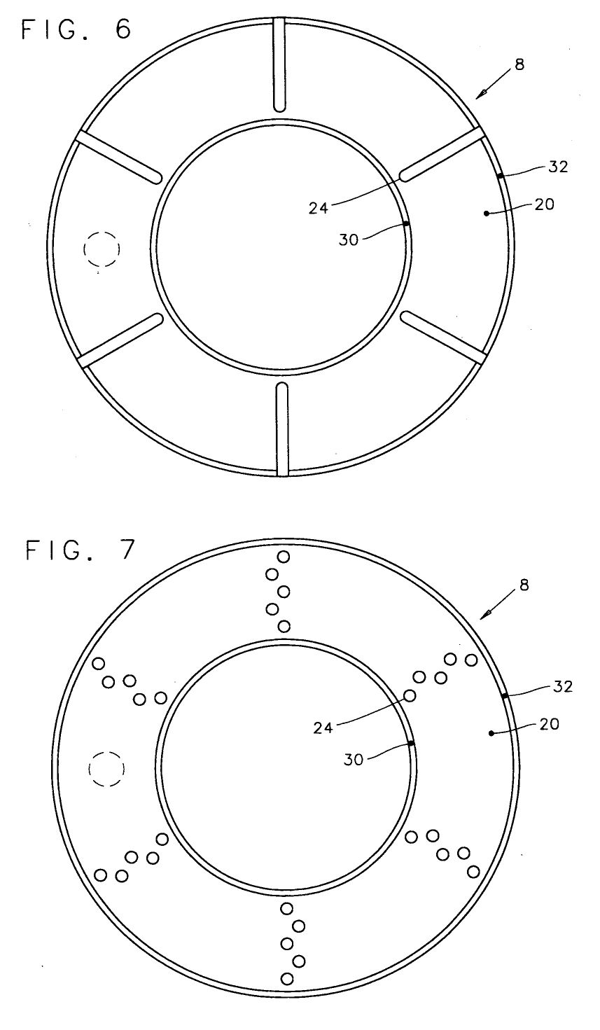

FIG. 1B is a fragmentary section view taken along lines 1B-1B of FIG. 1;

FIG. 1C is an exploded view of the hydrodynamic thrust bearing assembly of FIG. 1;

FIG. 1D is an enlarged fragmentary section view similar to FIG. 1B, and showing elastic deflection under thrust loading with the deflection exaggerated for clarity;

FIG. 2 is a cross-sectional elevation view of an alternate embodiment of the hydrodynamic thrust bearing assembly of the present invention;

FIG. 2A is a cross-sectional elevation view of the hydrodynamic thrust bearing assembly of FIG. 2 shown in conjunction with a shaft and housing;

FIGS. 3-5 are cross-sectional elevation views of alternate embodiments of the hydrodynamic thrust bearing assembly of the present invention; and

FIGS. 6 and 7 are plan views of alternate embodiments of the thrust washer according to the present invention.

### DESCRIPTION OF THE PREFERRED EMBODIMENTS

The preferred embodiment of the thrust bearing assembly according to the present invention is generally referenced in FIG. 1 as reference numeral 2. FIGS. 1-1D illustrate a preferred embodiment of the hydrodynamic thrust bearing assembly 2 of present invention. With reference to FIG. 2A, one of the primary purposes of the thrust bearing assembly 2 of the present invention is to transfer a thrust load between one member, such as a housing H, and another member, such as a shaft S, of a machine where the housing H and the shaft S are relatively rotatable with respect to one another.

The preferred embodiment of the thrust bearing assembly 2 comprises three principal components: a support structure 6, a thrust washer 8, and a dynamic race 10. The thrust washer 8 is sandwiched between the support structure 6 and the dynamic race 10. Preferably, the thrust washer 8 has a dynamic washer surface 20 of substantially planar configuration and a static washer surface 16 that contact dynamic race 10 and support structure 6, respectively. The dynamic race 10 incorporates a dynamic race surface 18 of substantially planar configuration that faces the dynamic washer surface 20 of the thrust washer 8. The support structure 6 and the dynamic race 10 are relatively rotatable with respect to one another. The thrust washer 8 is stationary with respect to the support structure 6 and is therefore relatively rotatable with respect to the dynamic race 10.

Preferably, the support structure 6 is a generally ring-like component that incorporates a plurality of generally radially-oriented notches 12 defined by a plurality of pedestals 14 that contact and support the static washer surface 16 of the thrust washer 8 as shown in FIG. 1C. Preferably, the pedestals 14 have an end surface 13 that contacts the static washer surface 16. As a result, the support structure 6 preferably has a castellated appearance, with the notches 12 forming the crenellations. The notches 12 are preferably open-ended, passing completely through the local radial width of the support structure 6. Referring to FIG. ID, the area of the pedestal end surface 13 defines a washer support region and the area of each notch 12 between adjacent pedestals 14 defines a washer flexing region. Preferably, the washer support and flexing regions define a repetitive segment of the bearing assembly 2.

The number of notches 12 in the support structure 6 will typically vary from a minimum of 2 to 10 for bearing assemblies that are employed in oilfield mud motor sealed bearing assemblies, depending upon the thrust washer size, thickness, thrust washer material, and required load capacity. However, there is no upper limit to the number of notches 12 that may be employed in larger size thrust bearing assemblies 2 of the present invention used in equipment other than mud motor sealed bearing assemblies.

As shown in FIG. 1D, a lubricant 15 is provided to lubricate the bearing assembly 2. This lubricant may be a grease that is heavily loaded with solid lubricants such as graphite, molybdenum disulphide, polytetrafluoroethylene (“PTFE”), powdered calcium fluoride, or copper particles combined with one or more types of soap base. However, in order to minimize rotary seal damage and thereby prolong the effective life of the thrust bearing assembly 2 as well, it is preferred that the lubricant 15 be a liquid oil-type lubricant, especially a high viscosity, synthetic lubricant having a viscosity of 900 centistokes or more at 40° C.

As also shown in FIG. 1D, when a thrust load F is transferred through the thrust bearing assembly 2 of the present invention, the intermittent support provided by the pedestals 14 of the support structure 6 causes elastic deflection of the thrust washer 8, causing the thrust washer 8 to bow into the notches 12 of the support structure 6. This elastic deflection is shown in exaggerated scale in FIG. 1D for clarity. The load distribution causes the originally flat dynamic washer surface 20 to deflect, and establishes an initial convergent gap between dynamic race surface 18 and dynamic washer surface 20 that is known as a hydrodynamic fluid wedge 22. The presence of this initial gap ensures development of hydrodynamic lubrication action whenever relative rotation between thrust washer 8 and dynamic race 10 occurs.

During relative rotation between the support structure 6 and the dynamic race 10, the thrust washer 8 remains stationary relative to the support structure 6, and relative rotation occurs between the dynamic race surface 18 and the dynamic washer surface 20, causing the hydrodynamic fluid wedge 22 to sweep a film of the lubricant 15 into the dynamic interface between dynamic race surface 18 and dynamic washer surface 20.

The relative velocity and the convergent gap of the hydrodynamic fluid wedge 22 cause a hydrodynamic wedging action that creates a lubricant film thickness and pressure creating a lifting action that separates the dynamic race surface 18 from the dynamic washer surface 20. The film thickness varies from a minimum value of h₀ to a maximum value of h₁ as shown in FIG. 1D. The film pressures thus generated are high enough to eliminate the direct rubbing contact between the majority of the asperities of dynamic race surface 18 and dynamic washer surface 20. The lubricant film reduces friction and enhances bearing performance, allowing the bearing assembly 2 to operate cooler and withstand higher load and speed combinations than are possible with conventional non-hydrodynamic thrust washers. The bearing arrangement produces this hydrodynamic lubrication effect in either direction of motion because of the symmetry of the design. Due to the hydrodynamic pressure generation, the deflection of thrust washer 8 increases under relative rotation, as compared to the deflection under static load conditions.

The temperature reduction provided by the preferred embodiment of the present invention is of particular significance to applications where an elastomeric rotary shaft seal is positioned near the bearings to retain the bearing lubricant and to exclude abrasives. By reducing the bearing-generated heat, the rotary shaft seals are permitted to run cooler, which extends the service life of the rotary shaft seals, and therefore extends the equipment service life by preventing loss of lubricant 15 and preventing abrasive invasion of the bearings.

Preferably, the static washer surface 16 of the thrust washer 8 remains stationary with respect to the pedestals 14 of the support structure 6 during rotary operation due to the fact that the friction at this interface is significantly higher than at the hydrodynamically lubricated dynamic interface between dynamic race surface 18 and dynamic washer surface 20. In order to prevent potential slippage during operation, as well as during start-up, the static washer surface 16 and/or the pedestals 14 should be provided with a roughened surface finish to assure high friction. The roughened finish can be obtained by grit blasting or etching, or other equally suitable methods. If desired, the bearing assembly 2 can incorporate one or more anti-rotation features to provide engagement between the thrust washer 8 and the support structure 6 to prevent rotational slippage between the thrust washer 8 and the support structure 6. For example, as shown in FIG. 1A, an anti-rotation projection 26 can engage an anti-rotation recess 28 to positively prevent relative rotation between the support structure 6 and the thrust washer 8. The anti-rotation projection 26 can be formed in either the support structure 6 (as shown in FIG. 1A) or the thrust washer 8 (as shown in FIG. 4), with the anti-rotation recess 28 being formed in the other part.

If desired, the thrust washer 8 may incorporate one or more lubricant passages 24 to facilitate the feeding of the lubricant 15 more efficiently and directly into the hydrodynamic fluid wedge 22 without relying on hydrostatic pressure of the lubricant 15 to force the lubricant feed.

The lubricant passages 24 make the bearing assembly 2 more suitable for applications having low ambient pressure (such as in applications where the lubricant 15 is substantially at atmospheric pressure) by helping to prevent lubricant starvation. The lubricant passages 24 may also be positioned intermediate the locations of the pedestals 14 of the support structure 6 to provide the thrust washer 8 with additional flexibility as shown in FIG. 1D.

In downhole applications, such as the oilfield mud motor sealed bearing assembly, the lubricant pressure is typically balanced to the high ambient hydrostatic wellbore pressure. In such applications, the lubricant passages 24 are not necessary because the high hydrostatic pressure present downhole prevents the formation of any unpressurized regions or voids and automatically forces the lubricant 15 into the hydrodynamic fluid wedge 22 to maintain a continuous film at the dynamic bearing interface. In surface equipment, where such hydrostatic pressure is not present, the lubricant 15 can be supplied to achieve the lubricant feed to the bearing dynamic surface by incorporating lubricant passages 24.

In FIGS. 1-1D, the lubricant passages 24 take the form of substantially radially oriented slots or grooves that span the entire radial width of the thrust washer 8, however the lubricant passages 24 can take other suitable forms without departing from the spirit or scope of the invention. For example, the lubricant passages 24 may be substantially axially oriented holes as described later in conjunction with FIG. 7, or the slots of FIG. 6.

The presence of the lubricant passages 24 necessarily reduces the contact area of dynamic washer surface 20, and increases the average contact pressure at the dynamic washer surface 20 for a given thrust load. However, the increase in contact pressure is relatively small if the geometry of the lubricant passages 24 is kept small. Whenever lubricant passages 24 are incorporated in the dynamic washer surface 20, the intersections between the lubricant passages 24 and the dynamic washer surface 20 should be provided with edge-breaks such as radii or chamfers to minimize disruption of the lubricant film.

It is desirable to treat the dynamic washer surface 20 of the thrust washer 8 with a hard wear-resistant coating or other suitable wear-resistant surface treatment, and/or to make the thrust washer 8 from a wear-resistant material having good resistance to galling, such as hardened beryllium copper. The dynamic race surface 18 and/or dynamic washer surface 20 can, if desired, be treated with any suitable coating or overlay or surface treatment to provide good tribological properties, such as silver plating, carburizing, nitriding, STELLITE overlay (STELLITE is the registered trademark of the Deloro Stellite Company for a cobalt-based hard facing alloy), COLMONOY overlay (COLMONOY is the registered trademark of the Wall Colmonoy Company for a hard facing material), boronizing, etc., as appropriate to the base material and mating material that are employed.

Dynamic race surface 18 of the dynamic race 10 should be softer and less wear resistant than dynamic washer surface 20 for best bearing life, and to achieve the highest tolerance to overload conditions and when starting up under load. This can be achieved by coating the dynamic race surface 18 with silver, or with another relatively soft sacrificial coating. This can also be achieved by manufacturing the dynamic race 10 from a conventional composite bearing material such as a porous sintered bronze impregnated with PTFE; for example, the DPF bearing material sold by Glacier Garlock Bearings (GGB).

It is preferred that no silver plating be applied to dynamic washer surface 20 so that dynamic washer surface 20 is more tolerant of overload conditions. Since silver coating does provide a measure of boundary lubrication under overload conditions, it is instead preferred that the silver coating or other suitable sacrificial coating be applied to the mating dynamic race surface 18 rather than to dynamic washer surface 20. During overload conditions with such a preferred coating arrangement, and when starting up under load, the silver plating wears off uniformly from dynamic race surface 18 and does not affect the hydrodynamic wedging angle of the unplated dynamic washer surface 20.

Even though beryllium copper is mentioned as a suitable material choice for the thrust washer 8, any number of alternate suitable materials with appropriate elastic modulus, strength, temperature capability, and boundary lubrication characteristics can be employed without departing from the spirit or scope of the invention, such as (but not limited to) steel, STELLITE, ductile iron, white iron, etc. A thrust washer 8 constructed with a material having a higher elastic modulus will, however, require the support structure 6 to have different proportions than would be appropriate for a thrust washer 8 constructed with a material having a lower elastic modulus.

By proper design of the flexibility of the thrust washer 8, and the proportions of the support structure 6, the hydrodynamic performance can be adjusted to cover anticipated service conditions and cover a wide range of thrust loading. Flexibility is a function of washer thickness 52, the size and location of the lubricant passages 24 (if any), the elastic modulus of the thrust washer 8, and the number, shape and size of the notches 12 and pedestals 14 of the support structure 6. It can also be appreciated that it is possible to vary the hydrodynamic performance of individual repetitive segments within a given bearing assembly for all the various embodiments of load responsive, elastically flexing bearings shown and described herein (See, for example, FIG. 4).

The dynamic washer surface 20 is preferably provided with an inner edge-relief corner break 30 and an outer edge-relief corner break 32 to reduce edge loading and high edge stresses. For example, when the present invention is employed in oilfield mud motor sealed bearing assemblies, edge loading can be caused by unavoidable bending moments imposed on the rotating shaft of the mud motor by drilling forces.

As shown in FIG. 1A, the dynamic race 10 is preferably equipped with an undercut 34, preferably a peripheral undercut, that establishes a flexible ledge 36. When bearing edge loading occurs, flexure of the flexible ledge 36 significantly reduces edge stresses on the thrust washer 8. The flexible ledge 36 is designed to have sufficient stiffness to provide load support to the thrust washer 8, yet be flexible enough to significantly reduce edge loading contact stress to reduce wear of the dynamic washer surface 20 and the dynamic race surface 18.

In the embodiment of FIGS. 1-1D, the support structure outside diameter (“OD”) 38 and the washer OD 40 are larger than the race OD 42. This configuration, which is common in prior art rolling element thrust bearings, allows the support structure 6 and the thrust washer 8 to be guided (i.e. laterally located) by a close fit with a housing bore (not shown), and allows the dynamic race 10 to have clearance with the housing bore. The support structure inside diameter (“ID”) 44 and the washer ID 46 are larger than the race ID 48. This configuration, which is common to the prior art, allows the dynamic race 10 to be guided (i.e. laterally located) by a close fit with a shaft (not shown), and allows the support structure 6 and the thrust washer 8 to have clearance with the shaft. If desired, the support structure 6 can be an integral part of the housing, and/or the dynamic race 10 can be an integral part of the shaft.

When subjected to heavy downhole impact loads, the conventional rolling element bearings used in mud motor sealed bearing assemblies are prone to fatigue damage and brinelling (e.g. denting) of the race surfaces. The preferred embodiment of the present invention is able to withstand much higher momentary impact loads by virtue of the hydrodynamic lubricating film in the dynamic interface between dynamic race surface 18 and dynamic washer surface 20, and the large dynamic support area, which film and area together provide a classical squeeze-film cushioning effect. When a momentary impact causes the lubricant film to be rapidly squeezed, it cannot escape instantaneously. The magnitude and duration of the load determines the reduction in film thickness, and the load that can be supported. In general, the preferred embodiment of the present invention is able to handle impact loads more than three times the dynamic design load limit.

In some applications, such as oilfield rotating diverters, thrust bearings must start rotation under heavily loaded conditions, which can result in high startup torque and premature wear to the thrust washer 8 and/or dynamic race 10. As shown in FIGS. 1, 1A, 1C, 2 and 4, this can be addressed, if desired, by routing pressurized lubricant through a pattern of pressure communication holes 50 in the dynamic race 10 that communicate with the interface between dynamic race surface 18 and dynamic washer surface 20. This creates an initial hydrostatic film that lubricates the dynamic race surface 18 and the dynamic washer surface 20 during startup, and improves film thickness during rotary operation.

The present invention was initially conceived for enhancing the wear capabilities of thrust bearings used in equipment such as oilfield downhole mud motor sealed bearing assemblies and to permit operation under high load and high speed combinations not possible with current state of the art rolling element bearing designs. The general operating principle of the present invention is also applicable to many other types of rotary equipment, with either the bearing housing or the shaft, or both, being the rotary member or members. Examples of such equipment include, but are not limited to, downhole drill bits, downhole rotary steerable equipment, rotary well control equipment, and equipment used in construction, mining, dredging, and pumps where bearings are heavily loaded, and other applications where space may be limited and operating conditions are severe.

It will be obvious to those skilled in the art that the geometry of the various embodiments of the present invention disclosed herein can be manufactured using any of a number of different processes, such as conventional machining, electric discharge machining, investment casting, die casting, die forging, etc.

The thrust bearing assembly 2 of the preferred embodiment of the present invention is more economical than the thrust bearings sold under Assignee's '635 Patent because the notches 12 forming the supported and unsupported regions of the present invention are machined into the support structure 6, rather than in the thrust washer 8. The thrust washer 8 is economical and simple in design. With the preferred embodiment of the present invention, and particularly with the embodiment shown in FIG. 3, there are no regions of the thrust washer 8 that are unduly thin because the notches 12 are machined into the support structure 6 rather than the thrust washer 8. As a result, the embodiment of FIG. 3, including the thrust washer 8, is able to withstand a significant amount of wear without fragmenting into segments. Furthermore, the economical and simple thrust washer 8 is disposable and replaceable whereas the more complex support structure 6 can be reused many times prior to replacing.

Features throughout this specification that are represented by like numbers have the same function. In the alternate embodiment of FIGS. 2 and 2A, the dynamic race 10 is designed to be guided by the housing H, while the support structure 6 and thrust washer 8 are designed to be guided by the shaft S. The support structure OD 38 and the washer OD 40 are smaller than the race OD 42. This allows the dynamic race 10 to be guided (i.e. laterally located) by a close fit with a bore of the housing H and allows the support structure 6 and the thrust washer 8 to have clearance with the housing bore as shown in FIG. 2A. The support structure ID 44 and the washer ID 46 are smaller than the race ID 48. This configuration, which is common to prior art rolling element thrust bearings, allows the support structure 6 and the thrust washer 8 to be guided (i.e. laterally located) by a close fit with the shaft S, and allows the dynamic race 10 to have clearance with the shaft S as shown in FIG. 2A. If desired, the support structure 6 can be an integral part of the shaft S, and/or the dynamic race 10 can be an integral part of the housing H.

The embodiment of FIG. 3 is a simplification of the embodiment of FIGS. 1-1D, and is identical in all respects except that the lubricant passages 24, anti-rotation projection 26, anti-rotation recess 28, undercut 34, flexible ledge 36, and pressure communication holes 50 of the embodiment of FIGS. 1-1D have been eliminated for the purpose of simplification in the embodiment of FIG. 3. The abutting surfaces of the support structure and/or the thrust washer can be roughened to inhibit rotational slippage there-between; i.e. between the pedestals 14 and the static washer surface 16.

It has been confirmed by finite element analysis that when the thrust washer 8 of the geometry shown in FIG. 3 is loaded statically, the elastic displacement of the thrust washer 8 creates an initial gap between dynamic race surface 18 and dynamic washer surface 20, forming a hydrodynamic fluid wedge. The presence of this initial gap ensures development of hydrodynamic lubrication action as soon as relative rotation between thrust washer 8 and dynamic race 10 is commenced, provided the lubricant has a high enough pressure to feed the lubricant into the hydrodynamic fluid wedge.

In the embodiment of FIG. 3, dynamic washer surface 20 is a substantially flat surface with no interruptions (e.g., grooves, slots, holes). This maximizes the surface contact area of the thrust washer 8, and minimizes the average bearing pressure for a given load.

With reference to FIG. 4, the thrust washer 8 may incorporate an anti-rotation projection 26 that engages one of the notches 12 of the support structure 6, which notch serves the same purpose as the anti-rotation recess 28 of FIG. 1A. The anti-rotation projection 26 locally increases the stiffness of the thrust washer 8, which varies the stiffness and hydrodynamic performance of this portion of the thrust washer 8, compared to the stiffness of the adjacent portion of the thrust washer 8. It is to be understood that the anti-rotation projection 26 may be configured in various shapes and sizes adapted to engage one of the notches 12.

Referring to FIG. 5, the thrust washer 8 may incorporate a weakening geometry 25 intermediate the pedestals 14 to increase the flexibility of the thrust washer 8 without taking away from the area of dynamic washer surface 20. In all other respects, the embodiment illustrated in FIG. 5 is identical to the embodiment illustrated in FIG. 3. As with the embodiment of FIG. 3, the embodiment of FIG. 5 is preferably suitable for applications where a high enough lubricant pressure exists to feed the lubricant into the initial load-induced convergent gap between the dynamic race surface 18 and the dynamic washer surface 20.

FIG. 6 shows that the lubricant passages 24 do not have to span the entire radial width of the thrust washer 8. Instead, such lubricant passages 24 may, if desired, span only part of the width and still accomplish the objective of feeding lubricant in applications with low lubricant pressure.

FIG. 7 shows a plan view of an embodiment of the thrust washer 8 in which the lubricant passages 24 are comprised of substantially axially oriented through-holes. The use of holes minimizes the loss of load bearing area while providing communication to feed lubricant to the hydrodynamic fluid wedge, and also provide the thrust washer 8 with additional flexibility intermediate the locations of the pedestals 14 of the support structure 6.

The dynamic washer surface 20 is substantially flat and uninterrupted except for the small interruption caused by the holes defining the lubricant passages 24. In the exemplary geometry shown in FIG. 7, there are two holes in one row and three holes in the other row. This permits the lubricant to be readily fed in the hydrodynamic fluid wedge under load.

The various preferred embodiments of the present invention relate to a load responsive, elastically flexing bearing design that provides hydrodynamic lubrication of the bearing dynamic surfaces in response to relative rotation. The hydrodynamic lubricating design permits the bearing to carry heavy loads at high speeds while generating less heat than prior art non-hydrodynamic thrust bearings, permits the bearing to be lubricated with liquid oil-type lubricants or greases, and permits the bearing to withstand higher impact loads than conventional rolling element thrust bearings. Unlike roller thrust bearings, the thrust bearing of the present invention can tolerate high impact loading without “Brinelling,” as a result of the classical “squeeze film effect” and a much larger support area.

In view of the foregoing it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

We claim:

1. A hydrodynamic bearing assembly for supporting and guiding a relatively rotatable member, the hydrodynamic bearing assembly comprising:
a support structure having a plurality of notches defined by a plurality of pedestals;
a race having a dynamic race surface; and
a thrust washer positioned between said support structure and said race, said thrust washer having a static washer surface facing said plurality of pedestals and a dynamic washer surface facing said dynamic race surface,
wherein each of said plurality of notches defines a washer flexing region.

2. The hydrodynamic bearing assembly of claim 1, further comprising an anti-rotation projection preventing rotational slippage between said support structure and said thrust washer.

3. The hydrodynamic bearing assembly of claim 2, wherein said anti-rotation projection projects from said support structure and engages an anti-rotation recess in said thrust washer.

4. The hydrodynamic bearing assembly of claim 2, wherein said anti-rotation projection projects from said thrust washer and engages said support structure.

5. The hydrodynamic bearing assembly of claim 1, wherein said thrust washer includes a lubricant passage.

6. The hydrodynamic bearing assembly of claim 5, wherein said lubricant passage is a recessed slot in said dynamic washer surface.

7. The hydrodynamic bearing assembly of claim 5, wherein said lubricant passage is a hole that passes through said thrust washer from said static washer surface to said dynamic washer surface.

8. The hydrodynamic bearing assembly of claim 1, wherein said race includes a plurality of pressure communication holes.

9. The hydrodynamic bearing assembly of claim 8, wherein each of said plurality of pressure communication holes passes substantially axially through said race.

10. The hydrodynamic bearing assembly of claim 1, wherein said race includes a peripheral undercut defining a flexible ledge.

11. The hydrodynamic bearing assembly of claim 1, wherein:
said race has a race outside diameter and a race inside diameter; and
said support structure has a support structure outside diameter and a support structure inside diameter,
wherein said race outside diameter is larger than said support structure outside diameter, and said race inside diameter is larger than said support structure inside diameter.

12. The hydrodynamic bearing assembly of claim 1, wherein:
said race has a race outside diameter and a race inside diameter; and
said support structure has a support structure outside diameter and a support structure inside diameter,
wherein said race outside diameter is smaller than said support structure outside diameter, and said race inside diameter is smaller than said support structure inside diameter.

13. The hydrodynamic bearing assembly of claim 1, wherein said thrust washer includes at least one weakening geometry intermediate two of said plurality of pedestals of said support structure.

14. The hydrodynamic bearing assembly of claim 1, wherein at least a portion of said static washer surface is roughened to increase friction between said plurality of pedestals of said support structure and said static washer surface of said thrust washer.

15. The hydrodynamic bearing assembly of claim 1, wherein at least a portion of said support structure is roughened to increase friction between said plurality of pedestals of said support structure and said static washer surface of said thrust washer.

16. The hydrodynamic bearing assembly of claim 1, wherein said dynamic race surface of said race is silver plated.

17. A load responsive, hydrodynamic bearing assembly for supporting and guiding a first member rotatable relative to a second member, the bearing assembly comprising:
a support structure having a plurality of notches defined by a plurality of pedestals;
a ring shaped race having a dynamic race surface; and
a ring shaped, flexible thrust washer positioned between said support structure and said race, said flexible thrust washer having a static washer surface contacting said plurality of pedestals and a dynamic washer surface facing said dynamic race surface,
wherein a plurality of flexing regions are defined by said plurality of notches.

18. The bearing assembly of claim 17, wherein during use in which the first member rotates relative to the second member, said dynamic race surface rotates relative to said dynamic washer surface forming a dynamic interface therebetween.

19. The bearing assembly of claim 18, wherein said flexible thrust washer is rotationally stationary relative to said support structure.

20. The bearing assembly of claim 18, wherein said plurality of notches are open-ended notches such that said static washer surface is not in contact with said support structure at said plurality of flexing regions.

21. The bearing assembly of claim 20, further comprising a lubricant lubricating said dynamic interface between said dynamic race surface and said dynamic washer surface during relative rotation therebetween.

22. The bearing assembly of claim 21, wherein said lubricant is a pressurized lubricant and a film of lubricant is swept into said dynamic interface during relative rotation between said dynamic race surface and said dynamic washer surface.

23. The bearing assembly of claim 21, wherein said flexible thrust washer is adapted to elastically deform in use to provide a hydrodynamic fluid wedge at said dynamic interface between said dynamic washer surface and said dynamic race surface.

24. The bearing assembly of claim 22, wherein said pressurized lubricant forms a gap between said dynamic race surface and said dynamic washer surface.

25. The bearing assembly of claim 17, wherein said dynamic washer surface is substantially planar.

26. The bearing assembly of claim 25, wherein said static washer surface is substantially planar.

27. The bearing assembly of claim 25, wherein said flexible thrust washer includes a plurality of lubricant passages.

28. The bearing assembly of claim 27, wherein said plurality of lubricant passages comprise a plurality of recessed slots in said dynamic washer surface.

29. The bearing assembly of claim 27, wherein said plurality of lubricant passages comprise a plurality of holes that pass through said flexible thrust washer from said static washer surface to said dynamic washer surface.

30. The bearing assembly of claim 25, wherein said race includes a plurality of pressure communication holes.

31. The bearing assembly of claim 30, wherein each of said plurality of pressure communication holes passes substantially axially through said race.

32. The bearing assembly of claim 18, wherein said flexible thrust washer elastically deforms in use to provide a hydrodynamic fluid wedge at said dynamic interface between said dynamic washer surface and said dynamic race surface.
